(19) United States
(12) Patent Application Publication
(10) Pub. No.: US 2009/0242408 A1
(43) Pub. Date: Oct. 1, 2009

(54) PHOTO-CATALYST CLEANING DEVICE

(75) Inventors: CHIH-PENG HSU, Hukou (TW); CHUNG-MIN CHANG, Hukou (TW); TSE-AN LEE, Hukou (TW)

Correspondence Address: PCE INDUSTRY, INC.;ATT. Steven Reiss, 288 SOUTH MAYO AVENUE, CITY OF INDUSTRY, CA, 91789, US

(73) Assignee: ADVANCED OPTOELECTRONIC TECHNOLOGY, INC., Hsinchu Hsien (TW)

(21) Appl. No.: 12/414,771

(22) Filed: Mar. 31, 2009

(30) Foreign Application Priority Data
Mar. 31, 2008 (CN) 200810300791.4

(51) Int. Cl. B03C 5/02

(52) U.S. Cl. 204/672; 204/660; 204/674

(57) ABSTRACT

A photo-catalyst cleaning device includes a first photo-catalyst layer and a first electrode plate. The first photo-catalyst layer is capable of generating electrons and holes when absorbing excitation light. The first electrode plate is positioned corresponding to the first photo-catalyst layer. The first electrode plate is capable of polarizing the electrons and holes generated from the first photo-catalyst layer when bias voltage is applied to the first electrode plate.

### CROSS-REFERENCE TO RELATED APPLICATION

This application is related to the following commonly-assigned copending application: Ser. No. 12/251,719, entitled “PHOTO-CATALYST AIR CLEANER.” The disclosure of the above-identified application is incorporated herein by reference.

### BACKGROUND

1. Technical Field

The present disclosure generally relates to a photo-catalyst cleaning device with an electrode.

2. Description of Related Art

In recent years, photo-catalyst materials have become widely used. Photo-catalyst materials, for example titanium dioxide (TiO₂), are excited by photo-energy to neutralize microbes and decompose pollutants.

When a photo-catalyst is irradiated with excitation light, such as ultraviolet light, electrons and holes are generated therein and migrate to the surface of the photo-catalyst. The electrons and holes produce surface oxidation to eliminate harmful substances such as organic compounds or nearby bacteria. That is, electrons reduce oxygen in the air to form superoxide ions (.O₂⁻), whereas holes degrade water adsorbed on the surface to form hydroxyl radicals (.OH). The superoxide ions and hydroxyl radicals are called activated oxygen species and show strong oxidizing effects.

When organic contaminants adhere to the photo-catalyst, superoxide ions deprive the organic compounds of carbon, and hydroxyl radicals deprive the organic compounds of hydrogen. Thereby, the organic compounds are decomposed. The decomposed carbon and hydrogen are oxidized to form carbon dioxide and water. That is, oxidative decomposition of organic substances occurs, and the photo-catalyst is said to have antifouling properties.

However, the photo-electric effect may be diminished or lost if the electrons and holes combine with each other, whereby not enough electrons and holes are available to respectively reduce oxygen in the air to form superoxide ions and degrade water adsorbed on the surface to form hydroxyl radicals.

Therefore, what is needed is a photo-catalyst device which can overcome the described limitations.

### BRIEF DESCRIPTION OF THE DRAWINGS

Many aspects of the present photo-catalyst cleaning device can be better understood with reference to the following drawings. The components in the drawings are not necessarily drawn to scale, the emphasis instead being placed upon clearly illustrating the principles of the present photo-catalyst cleaning device. Moreover, in the drawings, like reference numerals designate corresponding parts throughout the several views.

FIG. 1 is a schematic view of a photo-catalyst cleaning device in accordance with a first embodiment, the photo-catalyst cleaning device including an electrode plate spaced from a photo-catalyst layer, the electrode plate shown having a negative electrical bias applied thereto.

FIG. 2 is similar to FIG. 1, but showing the electrode plate having a positive electrical bias applied thereto.

FIG. 3 is a schematic view of a variation of the photo-catalyst cleaning device of the first embodiment, wherein the electrode plate directly contacts the photo-catalyst layer.

FIG. 4 is a schematic view of another variation of the photo-catalyst cleaning device of the first embodiment, wherein a buffer layer is interposed between the electrode plate and the photo-catalyst layer.

FIG. 5 is a schematic view of a photo-catalyst cleaning device in accordance with a second embodiment, the photo-catalyst cleaning device including an electrode plate spaced from a photo-catalyst layer, the electrode plate shown having a negative electrical bias applied thereto.

FIG. 6 is similar to FIG. 5, but showing the electrode plate having a positive electrical bias applied thereto.

FIG. 7 is a schematic view of a variation of the photo-catalyst cleaning device of the second embodiment, wherein the electrode plate directly contacts the photo-catalyst layer.

FIG. 8 is a schematic view of another variation of the photo-catalyst cleaning device of the second embodiment, wherein a buffer layer is interposed between the electrode plate and the photo-catalyst layer.

FIG. 9 is a schematic view of a photo-catalyst cleaning device in accordance with a third embodiment, the photo-catalyst cleaning device including two electrode plates and a photo-catalyst layer between the electrode plates.

FIG. 10 is a schematic view of a photo-catalyst cleaning device in accordance with a fourth embodiment, the photo-catalyst cleaning device including two electrode plates and two photo-catalyst layers between the electrode plates.

### DETAILED DESCRIPTION

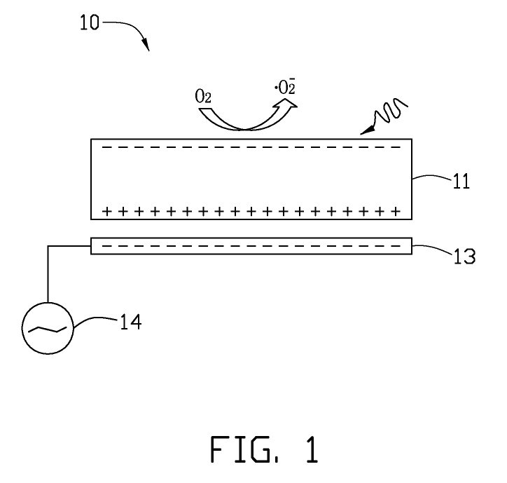

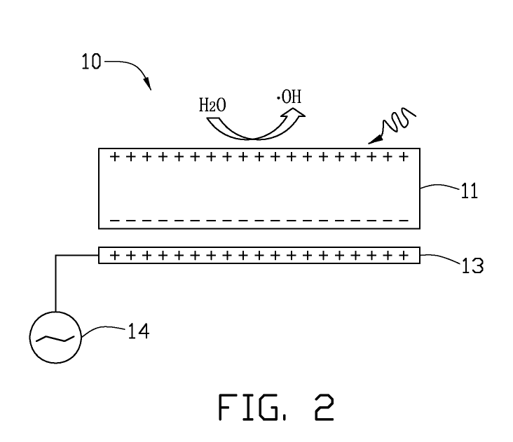

Referring to FIGS. 1 and 2, a photo-catalyst cleaning device 10, in accordance with a first embodiment, comprises a photo-catalyst layer 11, an electrode plate 13, and a power supply 14.

The photo-catalyst layer 11 is capable of generating electrons and holes when absorbing excitation light. The photo-catalyst layer 11 may for example be made of titanium dioxide (TiO₂), tin dioxide (SnO₂), zinc oxide (ZnO), tungsten trioxide (WO₃), iron oxide (Fe₂O₃), selenium titanium oxide (SeTiO₃), cadmium selenide (CdSe), potassium tantalite (KTaO₃), cadmium sulfide (CdS), or niobium pentoxide (Nb₂O₅). In this embodiment, the photo-catalyst layer 11 comprises nanometer sized titanium dioxide (TiO₂) particles. In this description, unless the context indicates otherwise, “nanometer sized” means that at least one dimension of a particle is in the range from greater than zero nanometers to less than 1,000 nanometers: i.e., >0 nm ˜<1000 nm.

The electrode plate 13 is positioned adjacent to but spaced from the photo-catalyst layer 11. The power supply 14 is electrically connected to the electrode plate 13 to apply bias voltage to the electrode plate 13. When the power supply 14 is used to apply bias voltage to the electrode plate 13, the electrons and holes generated from the photo-catalyst layer 11 can be polarized and separated from each other, so that combination of the electrons and holes with each other can be avoided.

As shown in FIG. 1, when a negative bias from the power supply 14 is applied to the electrode plate 13, the electrode plate 13 is negatively charged. When the photo-catalyst layer 11 is irradiated with excitation light (represented by a wavy arrow in FIG. 1), electrons and holes can be generated and migrate to the surfaces of the photo-catalyst layer 11. For example, the photo-catalyst layer 11 comprising nanometer sized titanium dioxide particles (having an absorption wavelength of about 388 nm) is exposed to ultraviolet excitation light. The electronegative electrode plate 13 can attract the holes and repel the electrons, such that the electrons and holes can be polarized and separate to two opposite sides of the photo-catalyst layer 11. In particular, the holes congregate at the side of the photo-catalyst layer 11 adjacent to the electrode plate 13, and the electrons congregate at the other side of the photo-catalyst layer 11 away from the electrode plate 13. The electrons can reduce oxygen in air to produce superoxide ions (.O₂⁻).

As shown in FIG. 2, when a positive bias from the power supply 14 is applied to the electrode plate 13, the electrode plate 13 is positively charged. When the photo-catalyst layer 11 is irradiated with excitation light (represented by a wavy arrow in FIG. 2), electrons and holes can be generated and migrate to the surfaces of the photo-catalyst layer 11. The electrode plate 13 can attract the electrons and repel the holes, such that the holes and electrons can be polarized and separate to two opposite sides of the photo-catalyst layer 11. In particular, the electrons congregate at the side of the photo-catalyst layer 11 adjacent to the electrode plate 13, and the holes congregate at the other side of the photo-catalyst layer 11 away from the electrode plate 13. The holes can degrade water adsorbed on the surface of the photo-catalyst layer 11, to form hydroxyl radicals (.OH).

In the present embodiment, the power supply 14 is an alternating current (AC) power source, and the negative bias and the positive bias can be periodically and alternately applied to the electrode plate 13. Thereby, the photo-catalyst cleaning device 10 can alternately generate superoxide ions (.O₂⁻) and hydroxyl radicals (.OH).

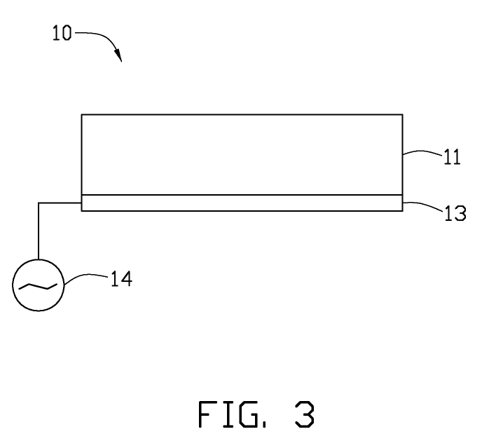

Referring to FIG. 3, the photo-catalyst layer 11 may be arranged to directly contact the electrode plate 13, such that the electrode plate 13 serves as a holder for the photo-catalyst layer 11. In this arrangement, the photo-catalyst layer 11 may be a nanometer sized (“nano-sized”) photo-catalyst film. In this description, unless the context indicates otherwise, “nanometer sized” means that a thickness of the photo-catalyst film is in the range from greater than zero nanometers to less than 1,000 nanometers; i.e., >0 nm ˜<1000 nm. The nano-sized photo-catalyst film can be attached to one surface of the electrode plate 13 by using an immersion, coating, or sintering process. The electrode plate 13 may be a filter screen with multiple holes.

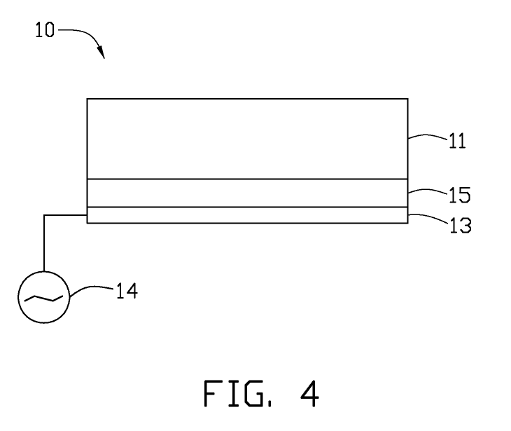

Referring to FIG. 4, this shows a buffer layer 15 interposed (sandwiched) between the electrode plate 13 and the photo-catalyst layer 11. In the present embodiment, the buffer layer 15 is in contact with both the electrode plate 13 and the photo-catalyst layer 11, and is configured for preventing the electrons or holes generated from the electrode plate 13 transferring to the photo-catalyst layer 11. The buffer layer 15 is comprised of one of semiconductor material and insulating material.

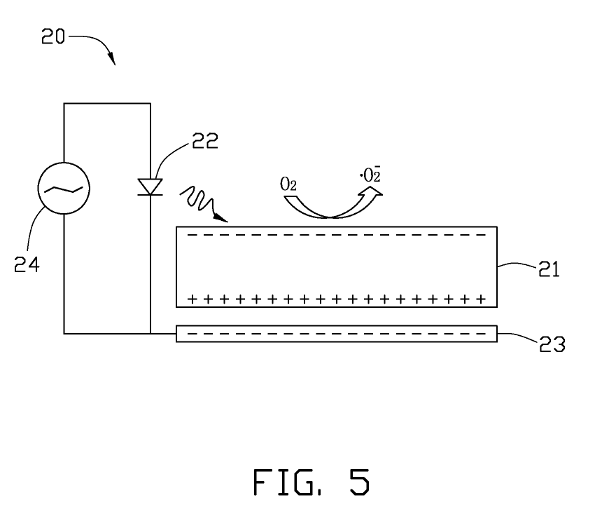

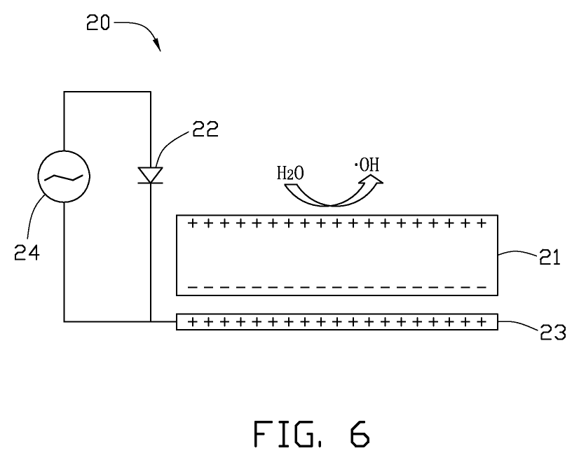

Referring to FIGS. 5 and 6, a photo-catalyst cleaning device 20, in accordance with a second embodiment, comprises a photo-catalyst layer 21, a light source 22, an electrode plate 23, and a power supply 24.

The photo-catalyst layer 21 is similar to the photo-catalyst layer 11 of the first embodiment. The light source 22 is electrically connected to the power supply 24. In the illustrated embodiment, the light source 22 has one-way electrical conduction, and can for example be a light emitting diode (LED). The light source 22 emits excitation light to irradiate the photo-catalyst layer 21. The photo-catalyst layer 21 can generate electrons and holes by absorbing the excitation light. The light emitting diode may for example be an ultraviolet light emitting diode (UV LED). The electrode plate 23 is spaced from the photo-catalyst layer 21. The power supply 24 is electrically connected to the electrode plate 23, and is configured for applying bias voltage thereto. When the power supply 24 applies bias voltage to the electrode plate 23, the electrons and holes generated from the photo-catalyst layer 21 can be polarized and separate from each other, so that combination of the electrons and holes with each other can be avoided.

As shown in FIG. 5, when the electrode plate 23 is negatively charged under negative bias applied by the power supply 24, the light source 22 is synchronously switched on to illuminate the photo-catalyst layer 21. When the photo-catalyst layer 21 is irradiated with the excitation light from the light source 22, electrons and holes can be generated and migrate to the surfaces of the photo-catalyst layer 21. For example, the photo-catalyst layer 21 comprises nanometer sized titanium dioxide particles (having an absorption wavelength of about 388 nm), and is exposed to ultraviolet excitation light. The electrode plate 23 can attract the holes and repel the electrons, such that the electrons and holes can be polarized and separate to two opposite sides of the photo-catalyst layer 21. In particular, the holes congregate at the side of the photo-catalyst layer 21 adjacent to the electrode plate 23, and the electrons congregate at the other side of the photo-catalyst layer 21 away from the electrode plate 23. The electrons can reduce oxygen in air to form superoxide ions (.O₂⁻), and synchronously the amount of electrons decreases because of their reaction with the oxygen.

As shown in FIG. 6, when the electrode plate 23 is positively charged under positive bias applied by the power supply 24, the light source 22 is synchronously switched off. The holes and the remaining electrons still congregate at the photo-catalyst layer 21. The electrode plate 23 can attract the remaining electrons and repel the holes, such that the remaining electrons congregate at the side of the photo-catalyst layer 21 adjacent to the electrode plate 23, and the holes congregate at the other side of the photo-catalyst layer 21 away from the electrode plate 23. The holes can degrade water adsorbed on the surface of the photo-catalyst layer 11, to form hydroxyl radicals (.OH).

In the above-described exemplary embodiment, the light source 22 is switched on and off alternately. Therefore consumption of electricity by the light source 22 can be effectively reduced, and the life span of the light source 22 can be extended.

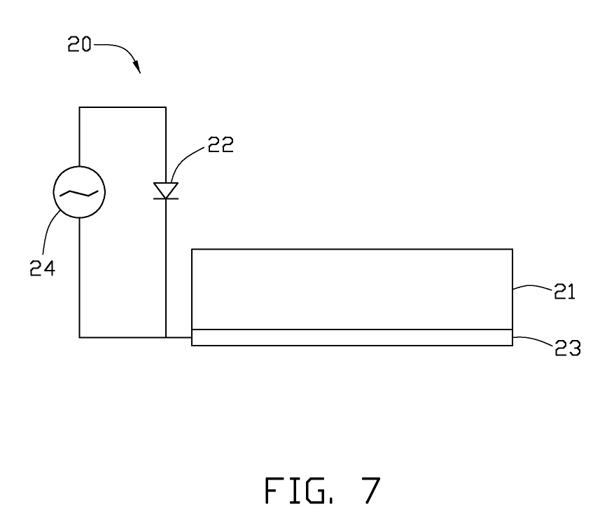

Referring to FIG. 7, the photo-catalyst layer 21 may be arranged to directly contact the electrode plate 23, such that the electrode plate 23 serves as a holder for the photo-catalyst layer 21. In this arrangement, the photo-catalyst layer 21 may be a nano-sized photo-catalyst film. The electrode plate 23 may be a filter screen with multiple holes.

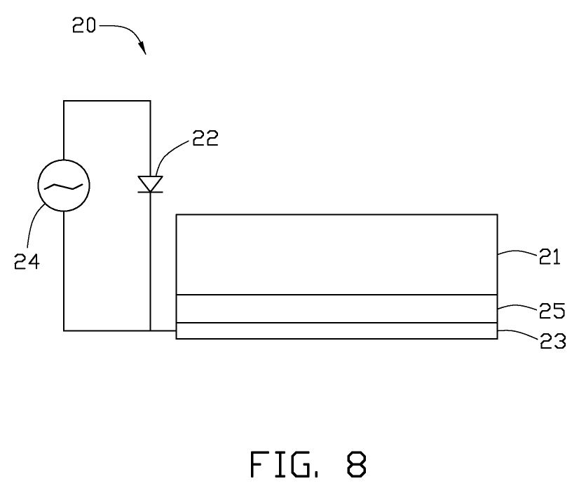

Referring to FIG. 8, this shows a buffer layer 25 interposed (sandwiched) between the electrode plate 23 and the photo-catalyst layer 21, and configured for preventing the electrons or holes generated from the electrode plate 23 transferring to the photo-catalyst layer 21. The buffer layer 25 is comprised of semiconductor or insulating material.

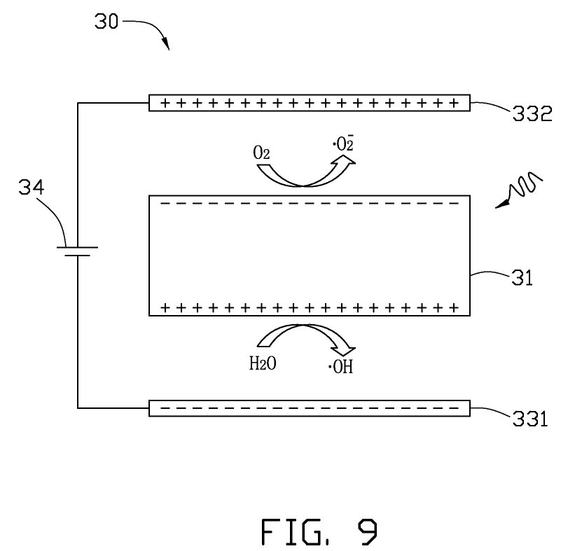

Referring to FIG. 9, a photo-catalyst cleaning device 30, in accordance with a third embodiment, comprises a photo-catalyst layer 31, a first electrode plate 331, a second electrode plate 332, and a power supply 34.

The photo-catalyst layer 31 is configured for generating electrons and holes by absorbing excitation light. The photo-catalyst layer 11 may for example be made of titanium dioxide (TiO₂), tin dioxide (SnO₂), zinc oxide (ZnO), tungsten trioxide (WO₃), iron oxide (Fe₂O₃), selenium titanium oxide (SeTiO₃), cadmium selenide (CdSe), potassium tantalite (KTaO₃), cadmium sulfide (CdS), or niobium pentoxide (Nb₂O₅). In this embodiment, the photo-catalyst layer 11 comprises nanometer sized titanium dioxide (TiO₂) particles.

The first and second electrode plates 331, 332 are respectively positioned adjacent to two opposite sides of the photo-catalyst layer 31. The power supply 34 is an AC power source. The first and second electrode plates 331, 332 are respectively electrically connected to two electrodes of the power supply 34, the electrodes having opposite polarities. The power supply 34 is configured for alternately applying two different sets of bias voltages to the first and second electrode plates 331, 332. In each set of bias voltages, two bias voltages having opposite polarities are applied to the first and second electrode plates 331, 332, respectively. For example, when the power supply 34 respectively applies negative bias and positive bias to the first and second electrode plates 331, 332, the holes and electrons generated from the photo-catalyst layer 31 can be polarized and separate to two opposite sides of the photo-catalyst layer 31. Thereby, combination of the electrons and holes with each other can be avoided. In particular, the holes congregate at the side of the photo-catalyst layer 31 adjacent to the first electrode plate 331, and the electrodes congregate at the other side of the photo-catalyst layer 31 adjacent to the second electrode plate 332. The holes can degrade water adsorbed on the surface of the photo-catalyst layer 31 to form hydroxyl radicals (.OH). The electrons can reduce oxygen in air to form superoxide ions (.O₂⁻). Thereby, particles adsorbed on the surfaces of the photo-catalyst layer 31 can be oxidized and decomposed.

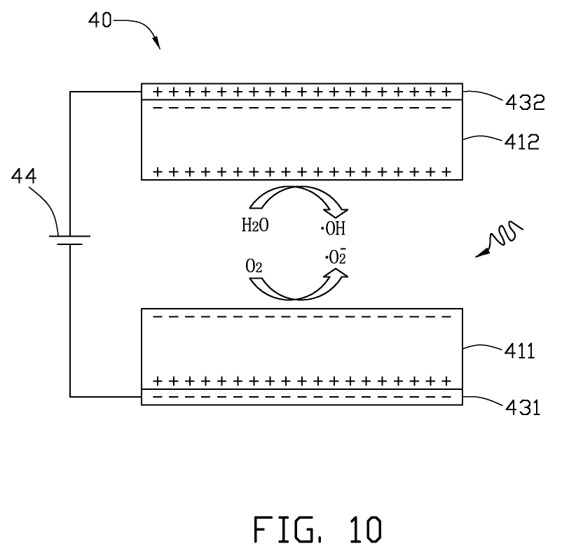

Referring to FIG. 10, a photo-catalyst cleaning device 40, in accordance with a fourth embodiment, comprises a first photo-catalyst layer 411, a second photo-catalyst layer 412, a first electrode plate 431, a second electrode plate 432, and a power supply 44.

The first and second photo-catalyst layers 411, 412 are configured for generating electrons and holes by absorbing excitation light. The first and second photo-catalyst layers 411, 412 may for example be made of titanium dioxide (TiO₂), tin dioxide (SnO₂), zinc oxide (ZnO), tungsten trioxide (WO₃), iron oxide (Fe₂O₃), selenium titanium oxide (SeTiO₃), cadmium selenide (CdSe), potassium tantalite (KTaO₃), cadmium sulfide (CdS), or niobium pentoxide (Nb₂O₅). In this embodiment, the photo-catalyst layer 11 comprises nanometer sized titanium dioxide (TiO₂) particles.

The first and second electrode plates 431, 432 are arranged to respectively directly contact the first and second photo-catalyst layers 411, 412. The first and second photo-catalyst layers 411, 412 are positioned between the first and second electrode plates 431, 432. The power supply 44 is an AC power source. The first and second electrode plates 431, 432 are respectively electrically connected to two electrodes of the power supply 44, the electrodes having opposite polarities. The power supply 44 is configured for alternately applying two different sets of bias voltages to the first and second electrode plates 431, 432. In each set of bias voltages, two bias voltages having opposite polarities are applied to the first and second electrode plates 431, 432, respectively. For example, when the power supply 44 respectively applies negative bias and positive bias to the first and second electrode plates 431, 432, the holes and electrons generated from each of the first and second photo-catalyst layers 411, 412 can be polarized and separate to two opposite sides of the respective first or second photo-catalyst layer 411, 412. Thereby, combination of the electrons and holes with each other can be avoided. In particular, the holes of the first photo-catalyst layer 411 congregate at the side of the first photo-catalyst layer 411 farthest from the second electrode plate 432, and the electrons of the second photo-catalyst layer 412 congregates at the side of the second photo-catalyst layer 412 farthest from the first electrode plate 431. The electrons of the first photo-catalyst layer 411 can reduce oxygen in air to form superoxide ions (.O₂⁻). The holes of the second photo-catalyst layer 412 can degrade water adsorbed on the surface of the second photo-catalyst layer 412 to form hydroxyl radicals (.OH).

In addition, any of the photo-catalyst layers 11, 21, 31, 411, and 412 may instead be structured with multiple layers. In particular, any one or more of the photo-catalyst layers 11, 21, 31, 411, and 412 may include a substrate, and a nano-sized photo-catalyst layer attached to the substrate. The nano-sized photo-catalyst layer can be attached to one surface of the substrate by using an immersion, coating, or sintering process. The substrate may be a filter screen with multiple holes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A photo-catalyst cleaning device, comprising:
a first photo-catalyst layer capable of generating electrons and holes when absorbing excitation light; and
a first electrode plate positioned corresponding to the first photo-catalyst layer, the first electrode plate capable of polarizing the electrons and holes generated from the first photo-catalyst layer when bias voltage is applied to the first electrode plate.

2. The photo-catalyst cleaning device of claim 1, further comprising a power supply, wherein the power supply is electrically connected to the first electrode plate to apply the bias voltage to the first electrode plate.

3. The photo-catalyst cleaning device of claim 2, further comprising a light source configured for emitting the excitation light.

4. The photo-catalyst cleaning device of claim 3, wherein the light source is electrically connected to the power supply.

5. The photo-catalyst cleaning device of claim 4, wherein the light source has one-way electrical conduction.

6. The photo-catalyst cleaning device of claim 5, wherein the power supply is an alternating current (AC) power.

7. The photo-catalyst cleaning device of claim 1, wherein the first electrode plate is spaced from the first photo-catalyst layer.

8. The photo-catalyst cleaning device of claim 1, wherein the first photo-catalyst layer is in direct contact with the first electrode plate.

9. The photo-catalyst cleaning device of claim 8, wherein the first photo-catalyst layer is a nano-sized photo-catalyst film.

10. The photo-catalyst cleaning device of claim 9, wherein the first electrode plate is a filter screen with multiple holes.

11. The photo-catalyst cleaning device of claim 1, further comprising a buffer layer interposed between the first photo-catalyst layer and the first electrode plate.

12. The photo-catalyst cleaning device of claim 11, wherein the buffer layer is comprised of one of semiconductor material and insulating material.

13. The photo-catalyst cleaning device of claim 1, further comprising a second electrode plate adjacent to the first photo-catalyst layer and positioned opposite to the first electrode plate, the second electrode plate capable of polarizing the electrons and holes generated from the first photo-catalyst layer when bias voltage is applied to the second electrode plate.

14. The photo-catalyst cleaning device of claim 13, further comprising a second photo-catalyst layer, wherein the first and second photo-catalyst layers are spaced from each other and located between the first and second electrode plates, and the first and second electrode plates are in direct contact with the first and second photo-catalyst layers, respectively.

15. The photo-catalyst cleaning device of claim 14, further comprising a power supply, wherein the power supply is electrically connected to the first and second electrode plates, and the power supply is an alternating current (AC) power supply.
